(19) United States
(12) Patent Application Publication
(10) Pub. No.: US 2007/0150853 A1
(43) Pub. Date: Jun. 28, 2007

(54) Method for processing assembly of data blocks using associated control application

(76) Inventor: Deepak Anant Deshpande, Katy, TX (US)

Correspondence Address: DEEPAK ANANT DESHPANDE, 1418 GREENWAY VILLAGE DRIVE, KATY, TX, 77494, US

(21) Appl. No.: 11/318,824

(22) Filed: Dec. 27, 2005

(51) Int. Cl. G06F 9/44

(52) U.S. Cl. 717/104

(57) ABSTRACT

A method to process an assembly of data blocks by using an associated control application. The individual data blocks comprise of diverse type of data such as files, tag separated data, digital data, text data, numerical data, binary data. Association of the data assembly with the control application is by (1) direct appending or (2) through another application or (3) through file extension and association tables. The data assembly is protected from unauthorized access. The changes during processing of data blocks are saved. Applications, included as data blocks in the data block assembly are executed by the control application to carry out parallel processes. New data blocks may be added to the data block assembly at any stage. The method produces self-contained distributable electronic data package where the data and code to process the data, are closely coupled.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates generally to distribution and management of electronic data on computers and more particularly to a method to assemble variety of electronic data, to place the assembled data on computers and eventually to process the assembled data in a predetermined manner by using a control application associated with the assembled data.

### BACKGROUND

A computer operating system has an apparatus such as File Manager to identify and manage files. Files related to a particular subject matter may be stored in identifiable common folder. Opening the folder though the File Manager can provide access to this collection of files. An example would be of all files related to a contract agreement stored in a common folder. However, the user has to remember the File Manager tree structure and traverse through it to access the folder and files therein. The sequence of the files in the given contract document may not be mapped by the File Manager in the folder. The user therefore either has to remember or find some way to map the sequence. Further the user has to open the files individually by clicking on the individual file icons, in order to view and process the file contents. If this contract document has to be emailed, the sender has to attach separate files or to create a zip package as an attachment to the email. Subsequently, when the recipient downloads the files, the sequence of the file in the attachment may be lost. This may hinder recipient's efficiency to understand relevance between the contract document and its attachment. Instead, it will be very convenient to assemble the contract document and its attachment in a single electronic booklet file. The user can open the booklet file in a single step and then scroll, forward and backward, through the booklet to access the individual files in a sequence in which they are placed in the contract document. The booklet may be emailed as single attachment without having to go through multiple steps of attaching individual files mentioned above. The electronic booklet can be conveniently stored on storage media where all the information relevant to the contract are available in one location, in a single data block and can be accessed coherently. Additional desirable feature would be for the electronic booklet to be read-only type so that the original content cannot be changed or overwritten.

As a security measure, a user may have to logon, by entering username and password, before gaining access to data on a computer. However, a successful logon grants access to all files and data belonging to the logged user. An access to files on a computer may be got by unauthorized personal through the Internet or by circumventing the logon protocol to the operating system and copying the file on an external storage media. It will be a valuable safeguard, if the user has to enter a username and password to gain authorized access to a particular file. The authorized user's identification data, in an encrypted form, could be attached to the file and migrated with file when the file is copied anywhere. This would prevent unauthorized use of the file whenever and wherever it is accessed.

In a database application the front end user interface is separate from the database. For example, in Microsoft operating system, the user interface application file coded in Microsoft Visual Basic® is separate from the Microsoft Access® database file. In most of the cases the database is on a server entirely separate from the client machine. For the UI-database system to work the server has to be accessible to the client. Such a architecture is not easily distributable. It would be very useful to extend to electronic data booklet file concept to produce a portable database. In this concept the front-end application file and the database file could be assembled into a single data block. The data block functions as n user interface as well as a data storage. Such an arrangement produces a distributable and shareable UI-database system that may be processed on standalone computers. Further, this UI-database assembly may be circulated, shared, processed and updated by a group of authorized users sequentially via the Internet without a need for a shared server.

There is always a need to optimize the processor time used by an application program. Every time an application program is executed, it repeats a set procedure according to a defined flow chart. This amounts to rerunning numerous processes on the processor to get and check the preliminary data, such as user's information, before executing the main objectives of the application program. Getting the preliminary data may sometimes need visits to servers via network and is time consuming. It will be very useful have the preliminary data in an encrypted form attached to the application file so that it is more readily available to the application, thereby reducing the processing time.

The tasks carried out by an application program are set when the application program is coded and compiled. The application program has to be modified and recompiled to include additional tasks. This amounts to rewriting and recompiling the code in the environment where the original code was created. This could be time and labor intensive. In some cases the original code development environment may not be available during modification stage. It will be very useful have a method to add new tasks to an application without having to modify and recompile the code. There would be an additional advantage, if adding of the task can be done from an environment that is independent of the environment in which the original code was developed.

### SUMMARY

A method where data blocks are first assembled to form a data block assembly termed here as Assembly. The individual data blocks may comprise of diverse type of data such as files, tag separated data, digital data, text data, numerical data, binary data. The Assembly is then associated with a control program. When necessary, the control program is executed to access, extract and process the data blocks in the Assembly. The method produces a self-contained distributable electronic data package where the data and the code to process the data, are closely coupled. The user works with this single electronic data package instead of having to deal with number of data sources. New data blocks may be added to the Assembly at any stage

Changes in the data blocks encountered during the processing may be saved. The original data blocks in the Assembly are than replaced by the modified data blocks. Being able to replace the original data blocks yields a read and write application.

The access rights of the user before accessing the Assembly may be checked using username and password. The encrypted user information is stored in one of the data blocks. This prevents unauthorized access of the data blocks. The Assembly is encrypted before associating it with the control program as guard against data piracy. To further ensure only authorized access to the Assembly, the Assembly is divided into at least two data segments. The first data segment is associated with the control program to yield a partial assembly. The second data segment is migrated to a remote machine, which is accessible through a network The second segment is downloaded from the remote machine by authorized user and appended to the first data segment to yield complete Assembly. The data blocks in the complete Assembly can now be accessed, extracted and processed by authorized user. The partial assembly may be safely distributed amongst users, without the possibility of unauthorized use of the data. Only after second data segment is legally downloaded and appended to the first data segment, is the data functional.

Some of the methods to associate the Assembly to the control program are: (a) appending the Assembly directly to the control program, (b) through an auxiliary application or (c) linking through the operating system with help of the file extension and association tables

The method is used to create an electronic booklet where the data blocks are separate document files. The user can access all the documents in the Assembly through a user interface presented by the associated control application, without having to use the File Manager. As an example, the document files may be sections of a contract document. The electronic booklet can be emailed as a packet so that the receiver of the email can download all the files in one step without having to store them separately in folders. The sequence of the files is also retained without the user having to remember or tag them in the File Manager.

The method may be used to create a self-executing User Interface-Database package. The data block is a data base file. The associated control application presents a user interface through which the user interacts with the database. The package is self-contained where the database is directly coupled with the front end. This avoids the time consuming access to the back end server via networks. The package may be circulated, shared, processed and updated by a group of authorized users sequentially via the Internet without a need for a shared server.

The data blocks in the Assembly can be application files termed here as Satellite applications. The associated control application executes the Satellite applications to carryout parallel processes. The launched Satellite application can operate independent of the control application. New Satellite application files can be added to the Assembly anytime. With this feature, the functionality of the electronic data package can be modified any time without having to change and recompile the control application. This saves time and labor. Many times, changing and recompiling the control application may not be possible because of the lack of the environment in which the control application was originally developed. Further, the Satellite applications can be deployed to execute parallel processes. Parallel processes can increases the flexibility and save overall processing time.

### BRIEF DESCRIPTION OF THE DRAWINGS

The features and advantages of the present invention will become more apparent from the following detailed description of the invention in which:

FIG. 1 is the block diagram illustrating the method covered in the present invention.

FIG. 2 illustrates Assembly with single and multiple data blocks.

FIG. 3 explains the concept of using control application to process associated Assembly.

FIG. 4 illustrates the method where the access to the Assembly is read and write.

FIG. 5 illustrates the method where control application is associated with the Assembly by appending.

FIG. 6 illustrates the method where control application is associated with the Assembly through auxiliary application.

FIG. 7 illustrates the method where control application checks the access rights of the user before accessing the Assembly.

FIG. 8 illustrates the steps to create and process an electronic booklet of document files.

FIG. 9 illustrates the steps to create and process self-executing UI-database application.

FIG. 10 illustrates the method using distributed data segments to prevent unauthorized access to the Assembly.

FIG. 11 illustrates the method using Satellite Application Programs to carryout parallel processes.

### DETAILED DESCRIPTION OF INVENTION

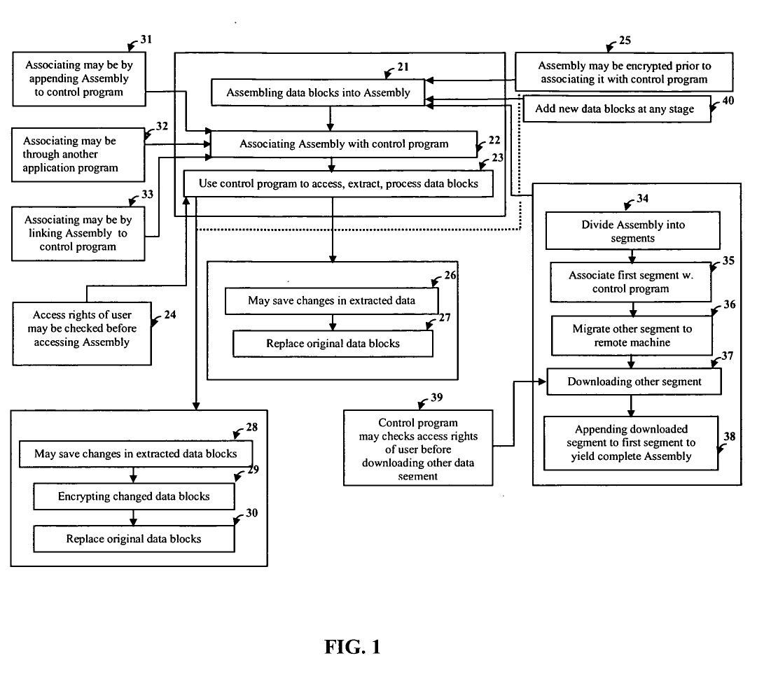

FIG. 1 is a block diagram for the method presented in the invention. The blocks of data are first assembled 21 to form a data block assembly termed here as Assembly. The Assembly is then associated with the control program 22. When necessary, the control program is executed 23 to access, extract and process the data blocks in the Assembly. Changes in the data blocks encountered during the processing, referred in 23, may be saved 26. The modified data blocks then replace the original data blocks in the Assembly 27. Being able to replace the original data blocks yields a read and write application. The access rights of the user before accessing the Assembly, referred in 23, may be checked 24 using username and password. This prevents unauthorized access of the data blocks. The Assembly may be encrypted 25, before associating it with the control program in 22, to further ensure only authorized access to the Assembly. The technique of encrypting Assembly referred in 25 may be used to encrypt the changed Assembly referred in 26. The changed data blocks are saved 28 and encrypted 29. The encrypted revised Assembly replaces 30 the encrypted original Assembly. This yields a read and write application with authorized access only. Some of the methods to associate the Assembly to the control program are: (a) appending the Assembly directly to the control program 31, (b) through an auxiliary application 32, (c) linking through the operating system with help of the file extension and association tables 33. To further ensure only authorized access to the Assembly, the Assembly is divided 34 into at least two data segments. The first data segment is associated 35 with the control program to yield a partial assembly. The second data segment is migrated 36 to a remote machine, which is accessible through a network. At this stage the data segment associated with control program is incomplete and cannot be processed. After the second segment is downloaded 37 from the remote machine via the network and appended to the first data segment 38 is the Assembly complete. The complete Assembly can be accessed, extracted and processed 23. The option to check the users right to download the second data segment, referred in 37, may be used 39. New data blocks may be added to the Assembly at any stage 40.

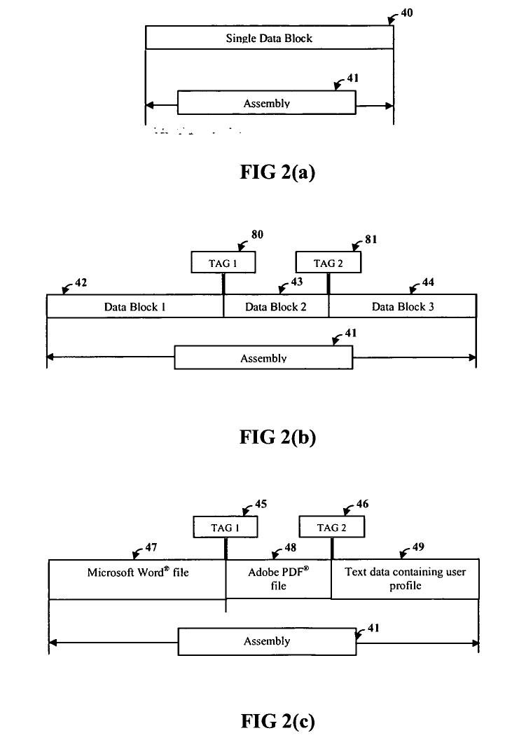

FIG. 2 explains the concept of data block assembly termed here as Assembly. Data blocks comprise of any data that can be read by the processor. Assembly 41 may comprise a single block of data 40 or more than one block of data 42, 43, 44. If multiple blocks of data are involved, they are joined together to yield the seamless Assembly. Appropriate separation markers (Tags) 80, 81 are inserted between the data blocks to mark the boundary between the two data blocks. Few examples of data blocks are: any type of files, tag separated data, digital data, text data, numerical data, binary data. This list should not be considered all-inclusive. FIGS. 2 (a) and (b) show Assembly with single data block and multiple data blocks respectively. Assembly of data blocks with different format is shown in FIG. 2(c). As an example, the data blocks may be a Microsoft Word® file 47, Adobe PDF® file 48 and text data 49 containing user profile such as usernames and passwords.

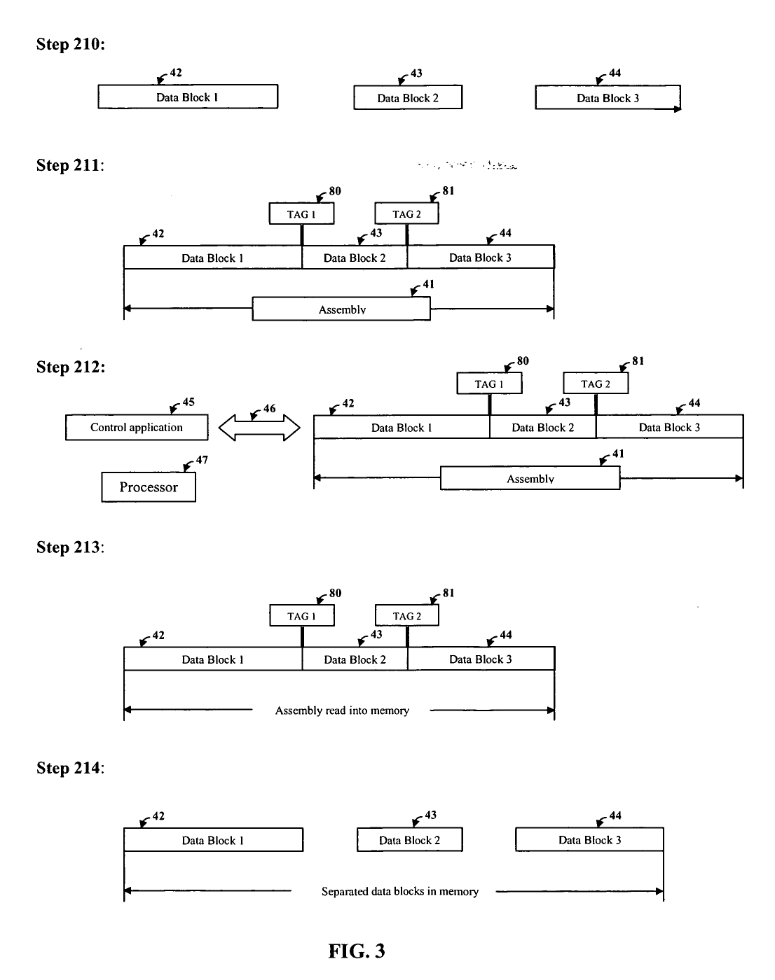

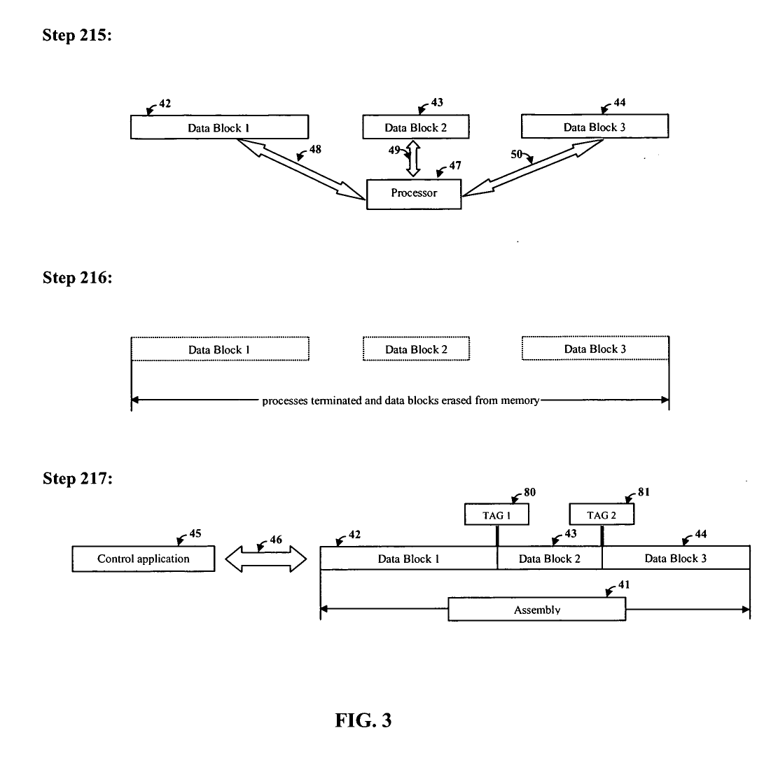

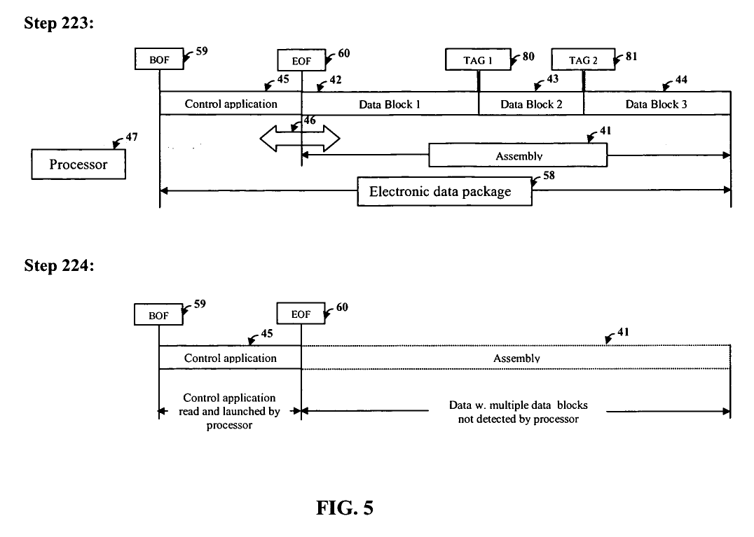

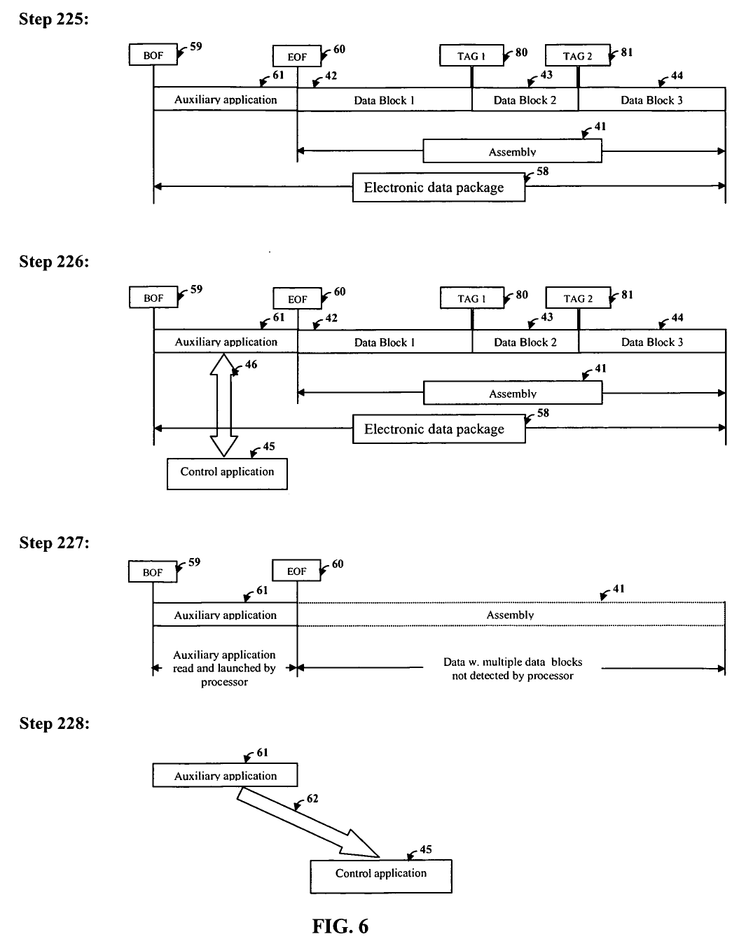

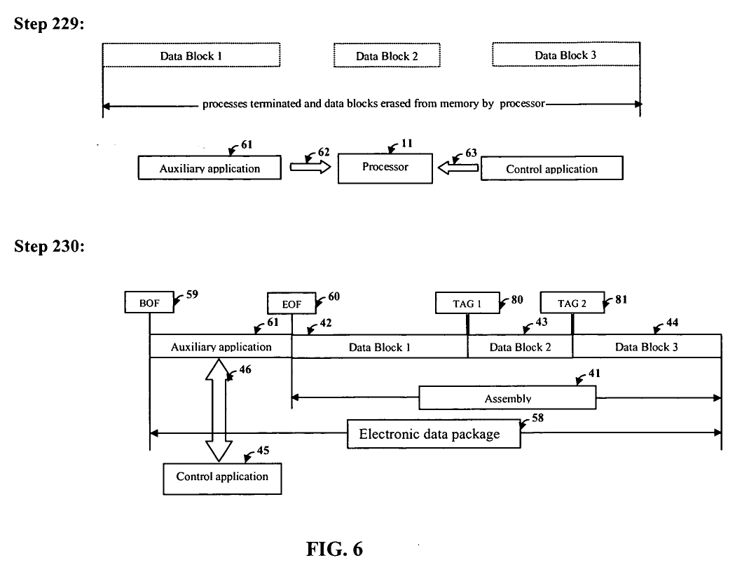

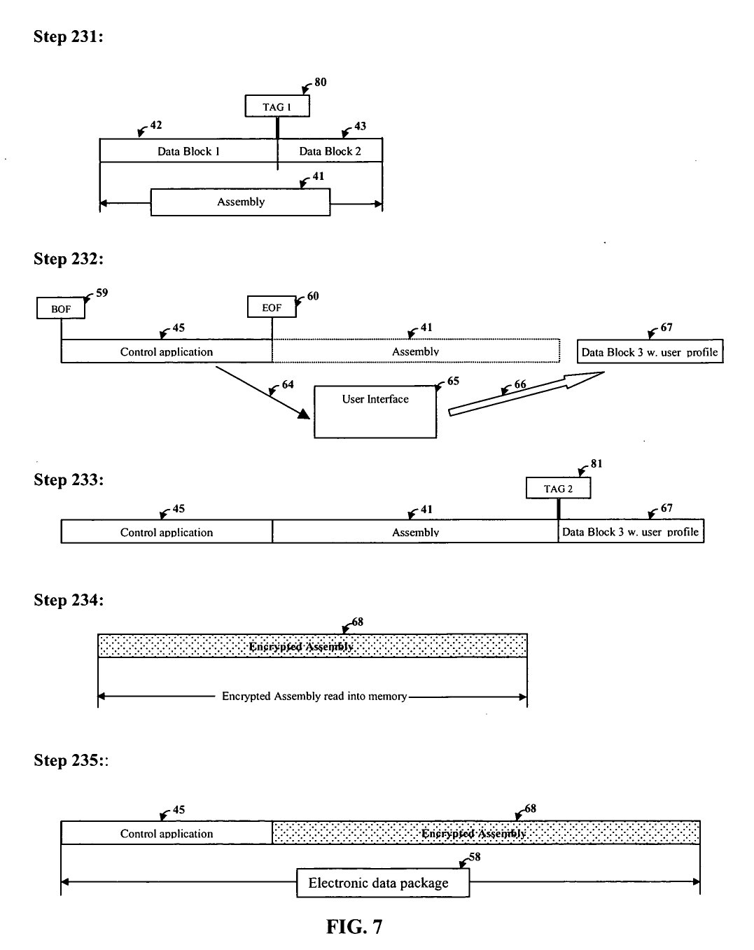

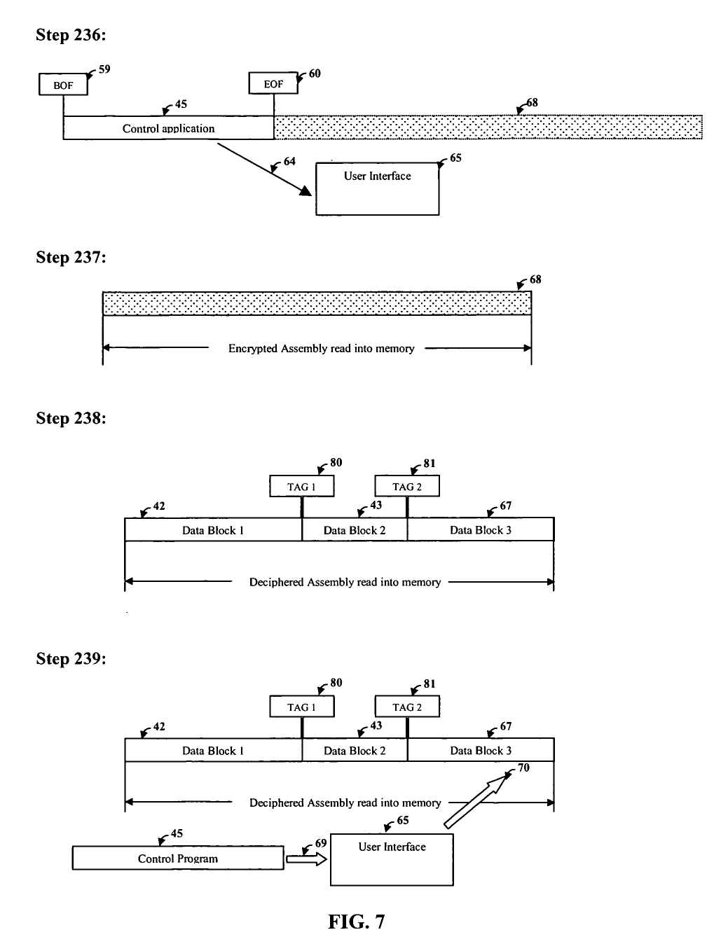

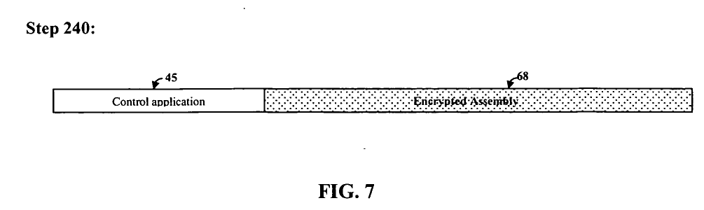

FIG. 3 explains the concept of processing an assembly of data blocks with the help of an associated control application. In step 210, data blocks 42, 43, 44 are initially separate. In step 211, the processor is instructed to assemble the data blocks 42, 43, 44 into an Assembly 41. The concept of the Assembly is same as explained in FIG. 2. The Assembly 41 is then associated 46 with the control application 45 in step 212. The association 46 enables execution of the control application code to carry out any of the following functions: assemble, append, encrypt, access, extract, decipher and process the associated data blocks as and when required. Some of the methods to associate the Assembly with control application are, but not limited to: (a) appending the Assembly directly to the control program (FIG. 5), (b) through an auxiliary control application FIG. 6, (c) linking through the operating system with help of the file extension and association tables. When launched, the control application instructs the processor 47 to read the entire Assembly 41 into the memory in step 213, then to separate the Assembly into the component data blocks in step 214 and to process 48, 49, 50 the individual data blocks as required in step 215. Some examples of the processes are: (a) opening a document file for viewing using the creating application, where one of the data block is a document file, (b) playing a video or audio file using the creating application, where one of the data block is a video or audio file, (c) reading, analyzing and utilizing information contained in a text string contained in one of the component data block. The user terminates the process directly (e.g. closes the document file window) or directs the control application to terminate the processes in step 216. After the processes are terminated, the processor is instructed by control application 45 to erase all the data blocks residing in the memory in step 216. This prevents unauthorized accesses to the data blocks after the control program is terminated. The control application terminates in step 217, leaving behind the Assembly with same structure as in step 212. The Assembly remains unaltered after every operating cycle (steps 213 through step 216) yielding a read-only Assembly. The Assembly may be encrypted before associating to the control application so that only authorized users may extract the data blocks. In such a situation, the control application deciphers the Assembly, before the processor can process it. The use of encrypted data is covered in more details in FIG. 7. The assembling, appending, encrypting, accessing, deciphering and processing of the data blocks is done according to a predetermine policy.

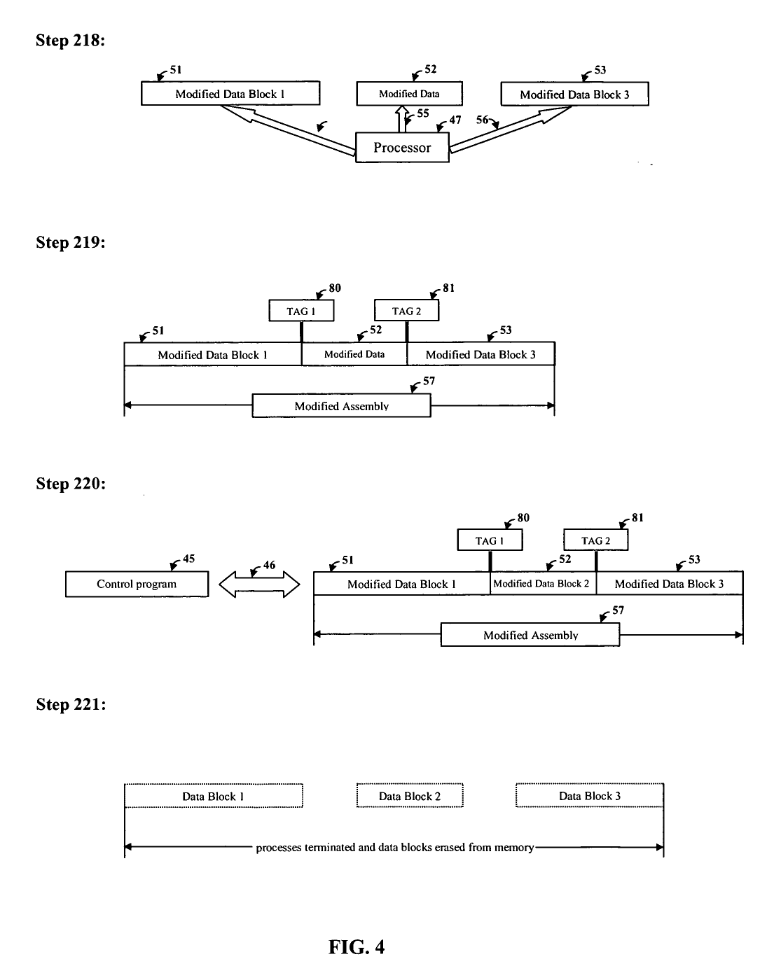

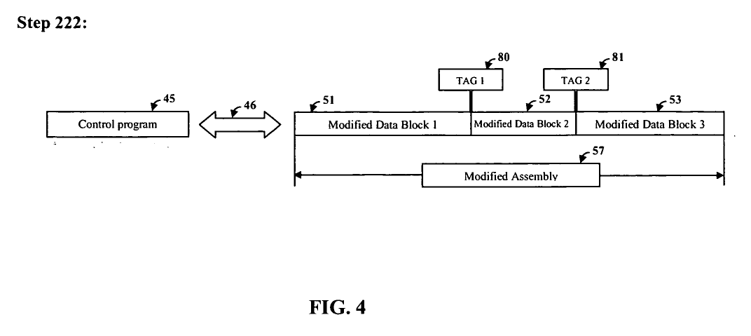

FIG. 4 along with FIG. 3 illustrates a manifestation of the method where the access to the Assembly is read and write. The data blocks are initially separate as in step 210. The data blocks are assembled in step 211 into an Assembly 41. The Assembly is associated with the control application 45 in step 212. The Assembly is read into the memory in step 213, separated into individual data blocks in step 214, and processed in step 215. The data blocks may change during the processing in step 215 which need to be saved. For example, a Microsoft Word® document may be edited by the user and it is necessary to save the changes. The processor is instructed through the control application to save 54, 55, 56 the changes in the memory in step 218. The modified data blocks 51, 52, 53 are then assembled into a modified Assembly 57 in step 219. The same policy used to assemble the original data blocks is used to assemble the modified data blocks. Instruction to assemble the modified data is given to the processor by the control application. In step 220 the control application 45 instructs the processor to replace the original Assembly with the modified Assembly. The processes are terminated in step 221 and all modified data blocks are erased from the memory in step 221. Finally, the control application terminates. This approach permits saving any changes in the data blocks encountered during the processing of the data blocks, resulting in a read and write application.

FIG. 5 along with FIG. 3 illustrates a manifestation of the method where the Assembly is associated with the control application by appending. As an example, the Assembly is comprised of multiple data blocks 42, 43, 44 as shown in step 210. The data blocks are assembled-into an Assembly 41 in step 211. The Assembly is associated 46 with the control application by appending the Assembly 41 to the control application 45 in step 223. The combination of control application 45 and the Assembly 41 forms an electronic data package 58. The control application 45 may be coded in any language that is compatible with the operating system on which the application is run. The Assembly 41 is not a part of the control application code 45 and is appended beyond the End of File (EOF) marker 60 of the control application file. The EOF marker identifies the boundary between control application 45 and the appended Assembly 41. When the control application is launched in step 224, the processor starts reading the content of the control application file from the Beginning of File marker (BOF) 59 and advances until it reaches the EOF marker 60. The data read by the processor between BOF marker 59 and EOF marker 60 is treated as the content of the control application code and executed accordingly in step 224. The processor does not consider the data beyond the EOF marker for executing of the control application. The appended Assembly beyond the EOF marker 60 may be read by code within the control application. To read the appended Assembly 41, the launched control application opens the electronic data package for reading (input), sets a pointer at EOF marker of control application file and reads the appended Assembly into the newly opened file as shown in step 213. The control application 45 further separates the Assembly 41 into the component data blocks 42, 43, 44 in step 214 and process the data blocks as required in step 215. This method yields a self-contained distributable electronic data package 58 that can process the data blocks contained within it. The Assembly essentially piggybacks on the control application. The data blocks can be accessed, extracted and processed as and when required by executing the control application. The Assembly is available to the control application wherever and whenever it is executed. As the control application and the Assembly are directly coupled, the access to the data blocks is simple, direct, reliable, exclusive and prompt. Time consuming process for accessing the data through network and servers is avoided. The user terminates or directs the control application to terminate the processes in step 216. After the processes are terminated, the processor is instructed to erase all the data blocks residing in the memory in step 216. The control application terminates in step 217.

The control application for method in FIG. 5 includes all the code to assemble, append, encrypt, access, extract, decipher and process the Assembly. This code may need large amount of memory. Including this lengthy control application code in every electronic data package can make the electronic data packages memory intensive. To avoid this situation, an alternate approach to associate Assembly with the control application is illustrated in FIG. 6 and FIG. 3. As an example, the Assembly is comprised of multiple data blocks 42, 43, 44 as shown in step 210. The data blocks are assembled in step 211 into an Assembly 41. The method has two applications termed here as control application 45 and auxiliary application 61. The Assembly 41 is appended to the auxiliary application 61 in step 225. The combination of auxiliary application 61 and the Assembly 41 forms an electronic data package 58. The control application 45 resides separate from the electronic data package 58 and is associated 46 with auxiliary application 61 in step 226. When the auxiliary application 61 is launched in step 227, the processor starts reading the content of the auxiliary application file from the BOF marker 59 and advances until it reaches the EOF marker 60. The data read by the processor between BOF marker and EOF marker is treated as the content of the auxiliary applicator code and executed accordingly in step 227. The function of auxiliary application 61 is only to launch 62 the control application 45 in step 228. The size of auxiliary application 61 is small because it has a specific and limited task. The function of control application 45 may be to assemble, append, encrypt, access, decipher and process the Assembly 41 appended to auxiliary application 61. This method allows any number of electronic data packages 58 to share a single control application file 45 and saves memory. Further, any changes in the code for control application 45 need to be made to a single file in one centralized location. The control program 45 reads the Assembly 41 into the memory in step 213. The control application further separates the Assembly into the component data blocks 42, 43, 44 in step 214 and process 48, 49, 50 the data blocks as required in step 215. Subsequently auxiliary application 61 or control application 45 or user instructs 62 or 63 processor 11 to terminate the processes in step 229. The control application 45 then instructs 63 the processor 11 to delete the data blocks from the memory in step 229. Finally both applications 45 and 61 terminate in step 230 leaving behind the electronic data package 58 unaltered. This results in a read only electronic data package. However, the control application 45 may be coded to save any modification in the data blocks encountered during the processing and then to replace the original Assembly with the modified Assembly as explained in FIG. 4, to yield a read and write Assembly.

Access to the associated Assembly may be granted only to authorized users, by coding the control application to perform the administrative function. The username-password concept may be used for this purpose. The username and password information may be stored in one of the data blocks. The entire Assembly is encrypted for security reasons. The control application deciphers the encrypted data when necessary. FIG. 7 along with FIG. 3 and FIG. 5 illustrates the method where the control application checks user's access rights before granting access to the associated Assembly. In step 231 the processor is instructed to assemble the data blocks 42, 43 into an Assembly 41. Separation marker (Tag) 80 is inserted between the data blocks to mark their boundary. The Assembly 41 is then associated with control application 45. For this illustration, the association is achieved by appending Assembly 41 to the control program 45 as shown in step 223. As mentioned earlier, appending is one of the many ways to associate the Assembly with the control application. In step 232, the control application 45 presents 64 a User Interface 65, through which the administrator creates 66 a username and a password for authorized users and stores them in a separate data block 67. In step 233, the control application 45 instructs the processor to append data block 67 to the Assembly 41, so that data block 67 is now included into the Assembly 41. A separation marker (Tag) 81 is placed between original Assembly and data block 67. Next the control application 45 reads the entire Assembly 41, which now includes data block 67, into the memory and encrypts it in step 234 to yield encrypted Assembly 68. In step 235, the control application 45 instructs the processor to replace the original Assembly 41 with the encrypted Assembly 68 to yield a electronic data package 58. When the control application 45 is launched, it presents 64 a User Interface 65 in step 236. The user is prompted to enter username and password in the User Interface 65. In step 237, the control application 45 instructs the processor to read the encrypted Assembly 68 into the memory and then to decipher it to yield the deciphered Assembly in step 238. In step 239, the control program reads 69 the information input by user in step 236 and compares 70 with the information residing in data block 67. Only if the two data are identical then the control application proceeds to step 214. Otherwise the deciphered Assembly is erased from the memory and the control application terminates. In step 214, the control application 45 separates the Assembly into the component data blocks 42, 43, 44 and processes them individually in step 215. When the control application or the user terminates the processes, the data blocks are erased from the memory in step 216. Finally when control application terminates, the data associated to it remains encrypted and unaltered, as shown in step 240, resulting in a read-only application, which may be accessed by authorized users only.

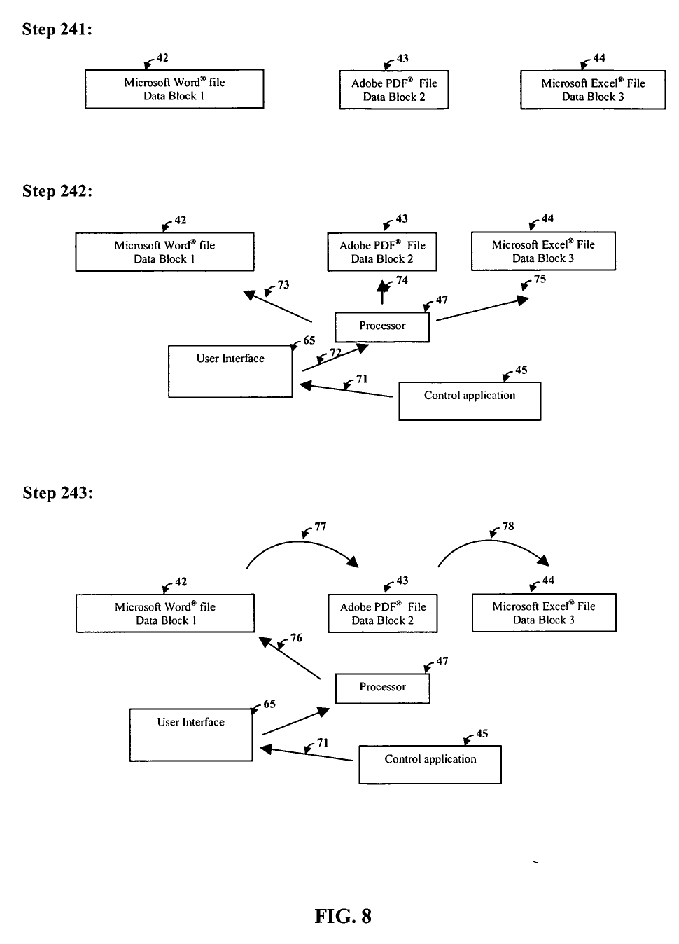

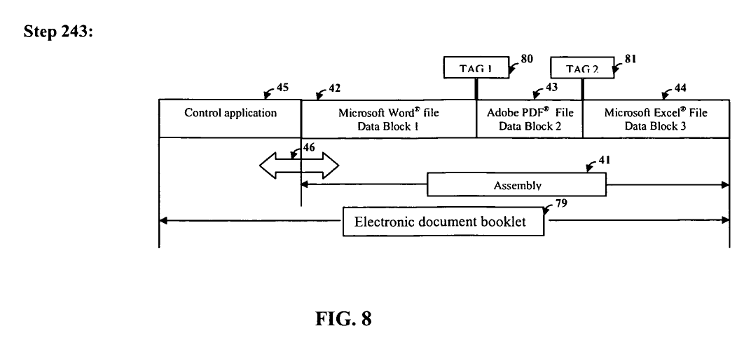

As mentioned in the section BACKGROUND OF INVENTION, there is a need for a method to generate an electronic booklet file where the user may work with a single electronic data package instead of having to deal with number of separate data sources. The usefulness of the electronic booklet file was explained in context with a contract document. FIG. 8 along with FIG. 3 and FIG. 5 illustrates the method to create an electronic booklet of document files. As illustrated in step 241, the data blocks are separate document files 42, 43, 44 that can be opened on the users machine with appropriate creating applications. These document files may be sections from a contract document. The collection of document files (data blocks 42, 43, 44) is assembled into a Assembly 41 in step 211. The sequence of the data blocks in the Assembly is the same as is in the contract document. The Assembly 41 is associated 46 with the control application 45 in step 212. As illustrated in step 223, the association 46 may be by appending Assembly 41 to the control program 45. The control application is coded to instruct the processor to read the Assembly 41 in the memory in step 213, separate the Assembly 41 into individual data blocks 42, 43, 44 (individual document files) in step 214 and to process them as required in step 215. The control application 45 may present 71 a User Interface 65 that instructs 72 the processor 47 to open the document files selectively, or all at one time 73, 74, 75 as show in step 242, or sequentially 76, 77, 78 as shown in step 243. The control application may be coded to check the user's authority to access the document files as described earlier. When required, the user or the control application close the document files as shown in step 216. The control application 45 deletes all the data blocks from the memory before terminating as shown in step 216. Finally when control application terminates, the data associated to it remains unaltered, as shown in step 243, resulting in a read-only application. It should be noted that the electronic document booklet 79 is a self-sufficient document and can operate in an operating environment where the control application 45 and the attached document files 42, 43, 44 can be processed. As an example, the control application 45 may be coded in Microsoft Visual Basic® language and the document files 42, 43, 44 may be a Microsoft Word® document, an Adobe Acrobat PDF® document, a MPG Video file, or a Microsoft Excel® spread sheet with macros as shown in step 241. Such a combination will operate successfully if the creating application and utilities, such as Microsoft Word®, Acrobat® Reader, Microsoft Office® and Real® Player are available to the user. The utilities to run the control application 45 should also be available. It may be realized that the electronic document booklet 79 allows the user an accesses to specific document files without having to search them through a File Manager. The electronic booklet can be emailed as a packet so that the receiver of the email can download all the files in one step without having to store them separately in folders. The sequence of the files is also retained without the user having to remember or tag them in the File Manager. As another example the electronic booklet would be very useful option for creating an electronic photo album were sequence of photos is many times important.

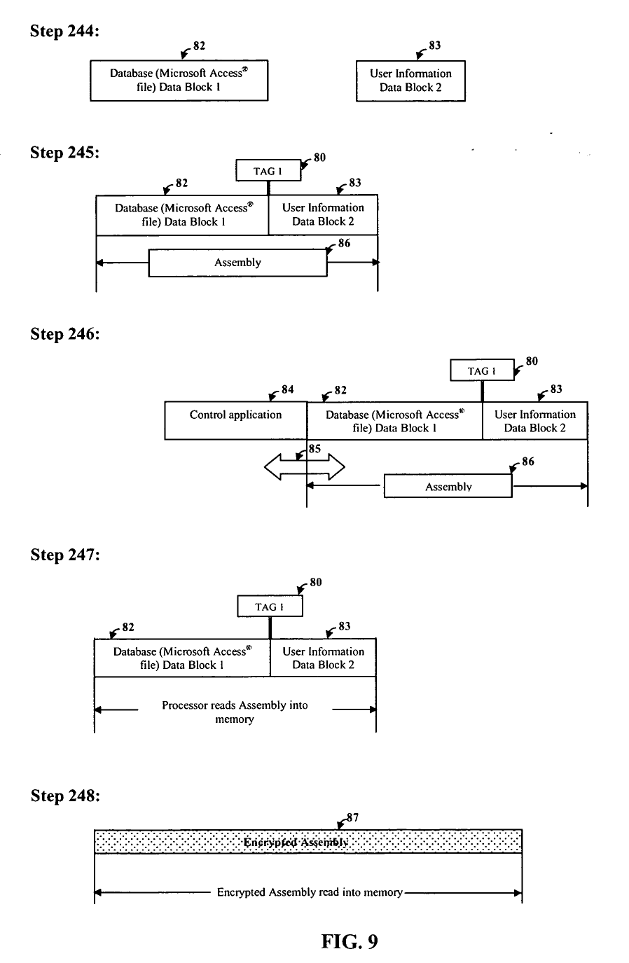

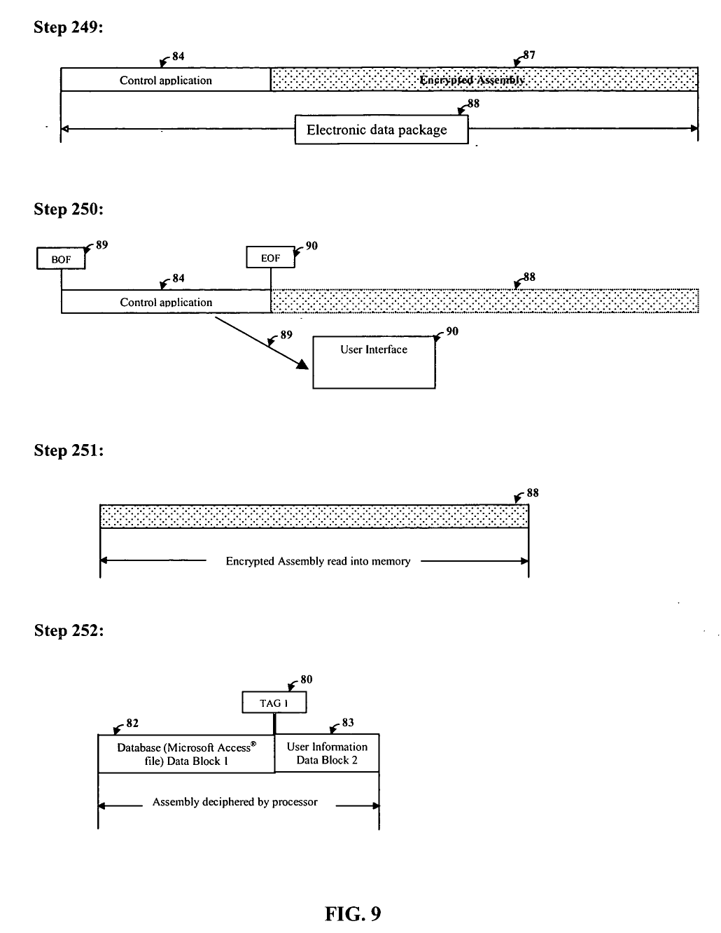

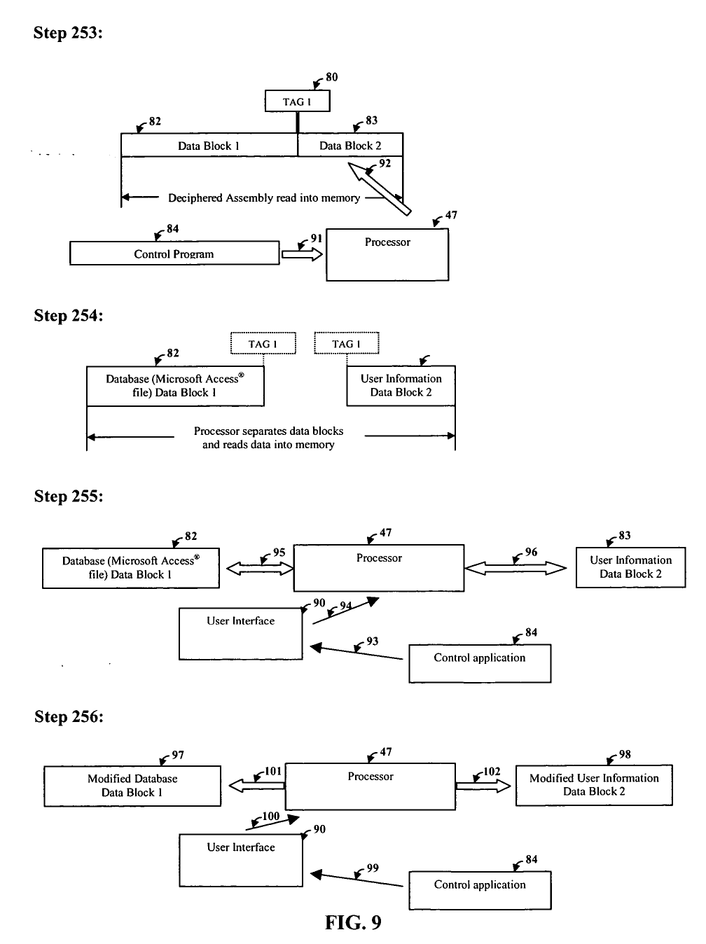

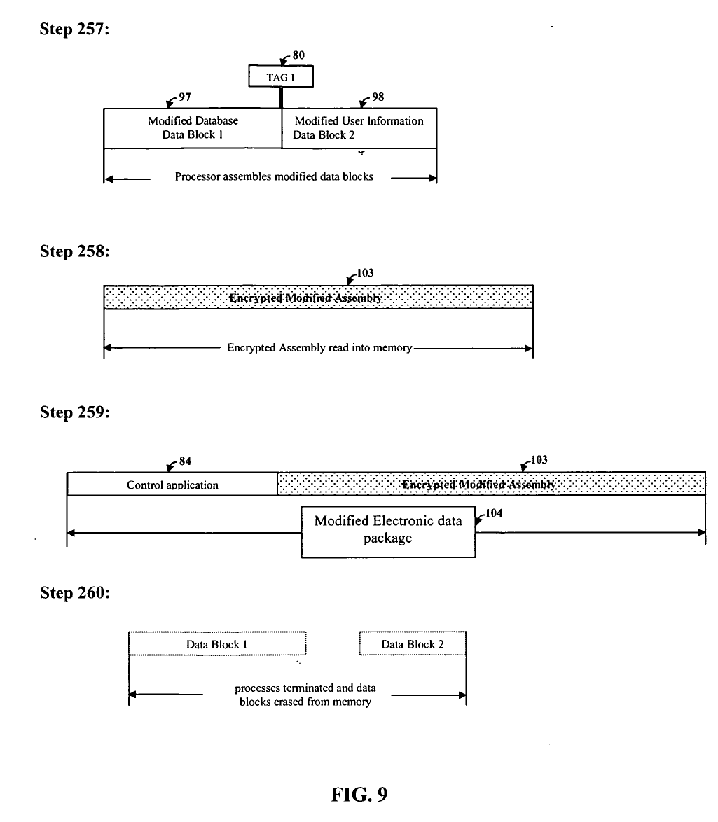

In another situation the Assembly associated with the control application may contain a database file. The control application interacts with the database through a user interface to process and store data. FIG. 9 illustrates a method for a self-executing User Interface-Database application. In step 244, the data blocks 82, 83 are initially separate. Data block 82 is a database file and data block 83 is a string that stores the user's information such username and password. In step 245 the processor is instructed to assemble the data blocks 82, 83 into an Assembly 86. Appropriate separation marker (Tag) 80 is inserted between the data blocks to mark the boundary between the two data blocks. In step 246, the processor is instructed to associate (append) 85 the Assembly 86 with the control application 84. As an example the control application 84 may be developed in Microsoft Visual Basic®, the database file can be in Microsoft Access® file and user information can be stored in a tag separated text file. In step 247, the control application 84 instructs the processor to read the Assembly 86 into the memory and to encrypt the Assembly as shown in step 248. In step 249, the encrypted Assembly 87 replaces the original Assembly 86. This yields an electronic data package 88 shown in step 249. In step 250, the control application 84 presents 89 a User Interface 90 where the user is prompted to enter the user information (typically username and password). In step 251, the control application 84 instructs the processor to read the encrypted Assembly 88 into the memory. In step 252, the control application instructs the processor to decipher the encrypted Assembly. In step 253, the control application 84 instructs 91 the processor 47 to validate 92 the information input by user (in step 250) with the information in data block 83. Only if the two data are identical then control application 84 proceeds further to step 254, otherwise the data blocks 82, 83 are deleted from the memory as shown in step 260 and the control application 84 terminates. In step 254, the control application instructs the processor to separate the data blocks. In step 255 the control application 84 presents 93 a User Interface 90 through which the user enters data to process 95, 96 the data blocks 82, 83. Some examples of the processes 95, 96 are, sending queries and receiving data, inputting, updating and saving data, checking user's username and password. In step 256, the control application 84, through the User Interface 90, instructs 100 the processor 47 to save 101, 102 the revised data blocks 97, 98 in the memory. The revision in the data blocks could be the changes in the database or the user information occurs during processing in step 255. In step 257, the control application 84 instructs processor to assemble modified data blocks 97, 98, to encrypt it to generate encrypted modified Assembly 103 in step 258 and then to replace the encrypted original Assembly 88 with encrypted modified Assembly 103 in step 259. The control application 84, before terminating, instructs the processor to erase the data blocks from the memory as shown in step 260. When the control application 84 terminates, the Assembly 103 attached to it remains encrypted and updated resulting in a read and write application, which may be accessed by authorized users only.

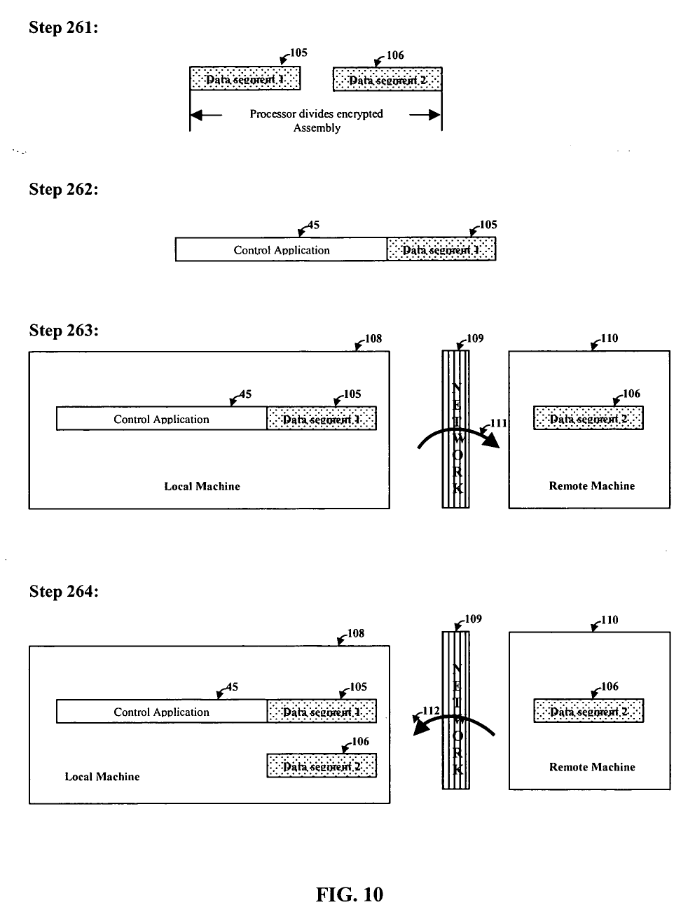

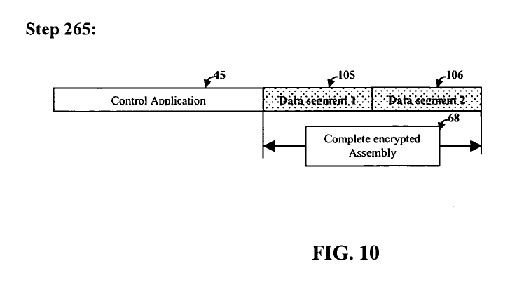

FIG. 10 along with FIG. 3, FIG. 5 and FIG. 7 outlines the method using distributed data segments to prevent unauthorized access to the Assembly. In step 231 the processor is instructed to assemble the data blocks 42, 43 into an Assembly 41. Separation marker. (Tag) 80 is inserted between the data blocks to mark their boundary. The Assembly 41 is then associated with control application 45. For this illustration, the association is achieved by appending Assembly 41 to the control program 45 as shown in step 223. As mentioned earlier, appending is one of the many ways to associate the Assembly with the control application. In step 232, the control application 45 presents 64 a User Interface 65, through which the administrator creates 66 a username and a password for authorized users and stores them in a separate data block 67. In step 233, the control application 45 instructs the processor to append data block 67 to the Assembly 41, so as to include data block 67 into the Assembly 41. A separation marker 81 is placed between original Assembly and data block 67. Next the control application 45 reads the entire Assembly 41, which now includes data block 67, into the memory and encrypts it in step 234 to yield encrypted Assembly 68. The processor is instructed to divide the encrypted Assembly 68 into at least two data segments 105, 106 in step 261. In step 262, the processor is instructed to associate (append) data segment 105 with the control application 45, which resides on the local machine. The processor is instructed to migrate 111 the data segment 106 to a remote machine 110 via network 109 in step 263. At this stage the single data segment 105 associated with control application 45 is an incomplete Assembly and cannot be processed. When necessary, the control application 45 is launched and it instructs the processor to download 112 data segment 106 from the remote machine 110 via the network 109 onto the local machine 108. As an additional step similar to step 236, the users rights to download data segment 106 may be checked before allowing access to data segment 106. The method to check user's rights is presented in FIG. 7. In step 265, the control application 45 instructs the processor to append the downloaded segment 106 to data segment 105. This yields the complete encrypted Assembly 68 associated (appended) with control application 45. When the control application 45 is launched, it presents a User Interface 65 in step 236. The user is prompted to enter username and password in the User Interface 65. In step 237, the control application 45 instructs the processor to read the encrypted Assembly 68 into the memory and then to decipher it to yield the deciphered Assembly in step 238. In step 239, the control program reads 69 the information input by user in step 236 and compares 70 with the information residing in data block 67. Only if the two data are identical then the control application proceeds to step 214. Otherwise the deciphered Assembly is erased from the memory and the control application terminates. In step 214, the control application 41 separates the Assembly into the component data blocks and processes them individually in step 215. When the control application or the user terminates the processes, the data blocks are erased from the memory in step 216. Finally when control application terminates and the data associated to it remains encrypted and unaltered, as shown in step 240, resulting in a read-only application, which may be accessed by authorized users only. The partial assembly in step 262 can be safely distributed amongst users, without the possibility of unauthorized use of the data. Only after data segment 106 is legally downloaded and appended to data segment 105 is the data functional.

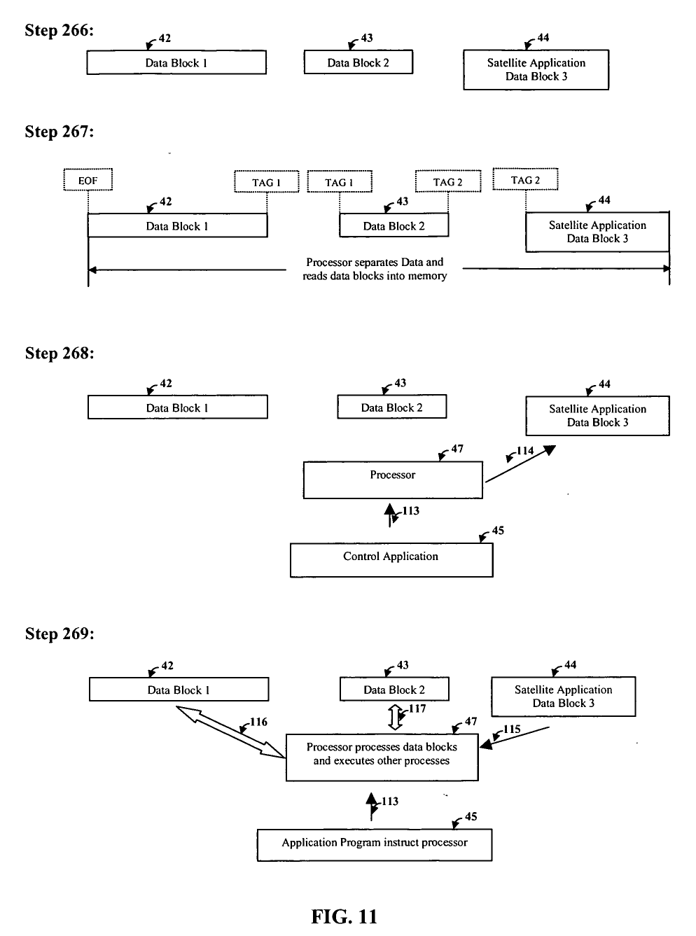

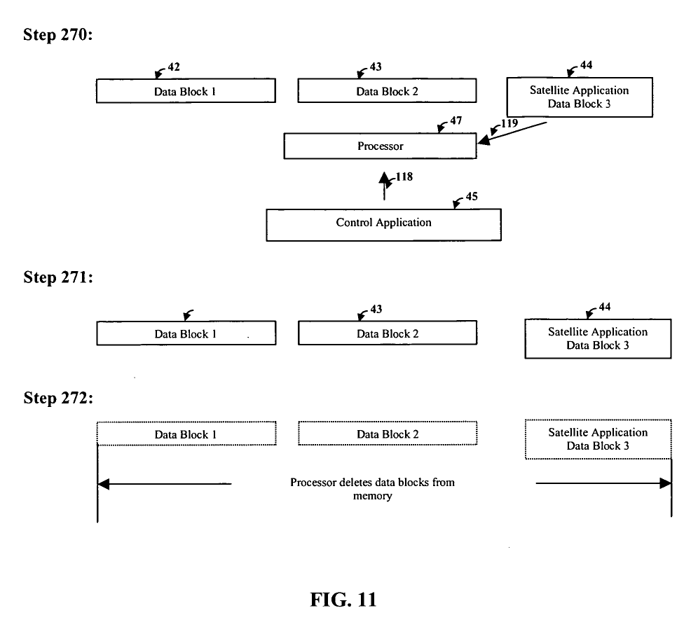

If one of the data blocks is an application file, termed here as Satellite application, the control application can launch the Satellite application. The launched Satellite application can operate independent of the control application. The Satellite application files can be added to the Assembly anytime. With this feature, the functionality of the electronic data package can be modified any time without having to change and recompile the control application code. This saves time and labor. Many times, changing and recompiling the control application code may not be possible because of the lack of the environment in which the control application was originally developed. Further, the Satellite applications can be deployed to execute parallel processes independent of the control application. Parallel processes can increases the flexibility and save overall processing time. FIG. 11 along with FIG. 3 and FIG. 5 illustrates the concept of Satellite application and its use to carryout parallel process. As shown in step 266, one of the data blocks is a Satellite application file 44. The Satellite application is an executable code that can run in the user's environment. Data blocks 42, 43, 44 are assembled into a Assembly 41 in step 211. The Assembly 41 is associated 46 with the control application 45 in step 212. As illustrated in step 223, the association 46 may be appending Assembly 41 to the control program 45. The control application instructs the processor to read the Assembly 41 into the memory in step 213, and separate the Assembly 41 into individual data blocks 42, 43, 44 in step 267. In step 268, the control application 45 instructs 113 the processor 47 to start 114 the Satellite application 44. The active Satellite application 44 can now instruct 115 the processor 47 to carry out processes 116, 117 as shown in step 269. These process 116, 117 could be independent of the processes already being carried by the control application 45 or could augment the processes which the control application is already carrying out. Parallel processes can be launched with this approach, leading to increased flexibility and saving in processor time. When required, the control application 45, the Satellite application 47 and the user terminate 118, 119 the processes as shown in step 270. In step 271, the Satellite application 47 terminates. In step 272, the control application instructs processor to delete the data blocks 42, 43, 44 from the memory. Finally the control application 45 terminates and the Assembly 41 attached to it remains unaltered, as shown in step 223, resulting in a read-only application. A new Satellite control application may be added to the Assembly at any stage. In this case the control application 45 should be originally coded to recognize the presence of the new Satellite application after it is appended to the Assembly and to launch it in the subsequent operations. The new Satellite application may augment the existing functionalities of the control application or add totally new functionalities.

What is claimed is:

1. A method to process an assembly of data blocks using a control application, the method comprising of:
assembling said data blocks according to an data block assembling policy;
associating said data block assembly with said control application according to an associating policy;
executing said control application when necessary to access, extract and process said data blocks.

2. The method in claim 1, where:
said data blocks comprise of any data readable by processor.

3. The method in claim 1, where:
said data blocks within the said assembly may have different formats.

4. The method in claim 1, further comprising of:
monitoring the data access rights of the user before accessing of said data block assembly.

5. The method in claim 1, further comprising of:
encrypting said data block assembly according to an encryption policy prior to said associating with said control program;
deciphering said encrypted data block assembly according to a deciphering policy after said extracting of said data block assembly.

6. The method in claim 1, further comprising of:
saving the changes in the extracted data blocks encountered during said processing of the data blocks;
replacing said associated original data blocks with corresponding changed data blocks.

7. The method in claim 5, further comprising of:
saving the changes in the extracted data blocks encountered during said processing of the data blocks;
encrypting said changed data blocks according to said encryption policy;
replacing said original encrypted data blocks with said encrypted changed data blocks.

8. The method in claim 1, further comprising of:
associating said data block assembly with said control application by appending said data block assembly to said control application.

9. The method in claim 1, further comprising of:
associating said data block assembly with said control application through auxiliary application by:
appending said data block assembly to said auxiliary application;
using said auxiliary application to execute said control application.

10. The method in claim 1, further comprising of:
associating said data block assembly with said control application through the operating system by means file extension and association tables.

11. The method in claim 1, further comprising of:
dividing said data block assembly into at least two data segments;
associating first of said data segment with said control application;
migrating second data segment to a remote machine accessible through network;
downloading said second data segment from said remote machine via said network;
appending the downloaded said second segment to said first data segment to yield complete data block assembly.

12. The method in claim 11, further comprising of:
monitoring the data downloading rights of the user prior to said downloading of said second data segment.

13. The method in claim 3, where:
said data block in said data block assembly is an application file;
said application file is launched by the said control application.

14. The method in claim 1, where:
new data blocks may be added to the said data block assembly at any stage.

15. The method in claim 1, further comprising a code with instructions that when executed by a computing device instructs the processor to:
assemble said data blocks according to a data block assembling policy;
associate said data block assembly with said control application according to an associating policy;
access, extract and process said data blocks.

16. The method in claim 4, further comprising a code with instructions that when executed by a computing device instructs the processor to:
monitor the data access rights of the user before letting access to said data block assembly.

17. The method in claim 5, further comprising a code with instructions that when executed by a computing device instructs the processor to:
encrypt said data block assembly according to an encryption policy prior to said associating with said control program;
decipher said encrypted data block assembly according to a deciphering policy after said extracting of said data block assembly.

18. The method in claim 6, further comprising a code with instructions that when executed by a computing device instructs the processor to:
save the changes in the extracted data blocks encountered during said processing of the data blocks;
replace said associated original data blocks with corresponding changed data blocks.

19. The method in claim 7, further comprising a code with instructions that when executed by a computing device instructs the processor to:
save the changes in the extracted data blocks encountered during said processing of the data blocks;
encrypt said changed data blocks according to said encryption policy;
replace said original encrypted data blocks with said encrypted changed data blocks.

20. The method in claim 8, further comprising a code with instructions that when executed by a computing device instructs the processor to:
append said data block assembly to said control application;
use the control application to access, extract and process the said data blocks.

21. The method in claim 9, further comprising a code with instructions that when executed by a computing device instructs the processor to:
append said data block assembly to said auxiliary application;
launch said control application by executing said auxiliary application;
use the control application to access, extract and process the said data blocks.

22. The method in claim 11, further comprising a code with instructions that when executed by a computing device instructs the processor to:
divide said data block assembly into at least two data segments;
associate first of said data segment with said control application;
migrate second data segment to a remote machine accessible through network;
download said second data segment from said remote machine via said network;
append the downloaded said second segment to said first data segment to yield complete data block assembly.

23. The method in claim 12, further comprising a code with instructions that when executed by a computing device instructs the processor to:
monitor the data downloading rights of the user, prior to said downloading said second data segment from said network.

24. An article comprising: a storage medium, storage medium comprising said code, control application file, said data block assembly file and said auxiliary application file accessible via user's machine.
